(19) United States
(12) Patent Application Publication
(10) Pub. No.: US 2011/0253408 A1
(43) Pub. Date: Oct. 20, 2011

(54) Method and System for a Down-hole Cable having a Liquid Bonding Material

(75) Inventors: Scott R. Magner, South Glastonbury, CT (US); Robert Konnik, South Windsor, CT (US); Dustin R. Dulac, West Hartford, CT (US); Clifford W. Westwood, Holyoke, MA (US); Daniel D. Masakowski, Westbrook, CT (US)

(73) Assignee: Rockbestos Surprenant Cable Corp., East Granby, CT (US)

(21) Appl. No.: 13/081,922

(22) Filed: Apr. 7, 2011

Related U.S. Application Data
(60) Provisional application No. 61/324,926, filed on Apr. 16, 2010.

(51) Int. Cl. H01B 7/00; B32B 37/14; B32B 37/12; H01B 13/06; B32B 37/06

(52) U.S. Cl. 174/24; 156/294; 156/275.5

(57) ABSTRACT

A system and method for a down-hole cable with a liquid bonding system is provided. Generally, the system contains at least one insulated conductor fully insulated by an insulation coating. An armor shell is positioned exterior to the insulating coating and fully surrounds the insulated conductor. A liquid bonding material is applied between at least a portion of an exterior surface of the insulation coating and at least a portion of an interior surface of the armor shell, wherein the liquid bonding material creates a bond between the insulation coating and the armor shell.

### CROSS REFERENCE TO RELATED APPLICATION

This application claims benefit of U.S. Provisional Application Ser. No. 61/324,926 filed Apr. 16, 2010, the entire disclosure of which is incorporated herein by reference.

### FIELD OF THE DISCLOSURE

The present disclosure is generally related to cables and more particularly is related to a method and system for a down-hole cable having a liquid bonding material.

### BACKGROUND OF THE DISCLOSURE

Down-hole cables are found in use in many industries including those that conduct deep drilling, such as within the oil drilling industry. These cables may be used to transmit information and data from a drilling region having the drilling equipment to a control center located remote to the drilling region. Many oil-drilling regions are located deep within the Earth's crust, such as those seen with onshore and offshore drilling. The drilling region may be 5,000 feet or more from a control center located on the Earth's surface or a control center located on water at sea level. A cable of 5,000 feet or more may have a high weight that, when located vertically down a drilling hole distorts the structure of the cable itself. This may result in a failure of the cable or a deformity of the cable that renders it more inefficient than a non-deformed cable.

Current cables include a filler constructed from solid polypropylene or similar material that surrounds one or more conductors and are enclosed with an armored sheath, such as a superalloy like Incoloy or a stainless steel. The purpose of the polypropylene filler is to provide a compressive force between the conductor core and the armored sheath, the compressive force retaining the conductor core within the cable. The compressive force produced by the solid polypropylene filler may counteract a gravity-based pullout force, which is the force necessary to slide the conductor core from the armored sheath. The polypropylene fillers that are used are rated at 150° C. and therefore are frequently unable to retain their integrity when the cable is being produced using a heated method. This is believed to be due to the inherent crystallinity of the extruded polypropylene filler and the after effect of additional heat cycles from the encapsulation extrusion of the armored sheath. These additional heat cycles cause a phase shift in the polypropylene, which in effect, reduce the diameter of the material, which lessens the pullout force necessary to compromise the cable. The encapsulation extrusion process may have temperatures that are greater than the annealing temperature of the polypropylene facilitating the phase shift. This process may result in a cable that can easily be damaged by its own weight creating a pullout force on the conductor core resulting in the conductor core moving within the cable.

Some conventional cables include bonded portions within the construction of the cable. FIG. 1 is an illustration of an electrical cable 10 in accordance with the prior art. The electrical cable 10 includes a plurality of individually-insulated conductors 11 and has an insulation layer 12, a jacketing layer 14 and a tie layer 16 between the insulation layer 12 and the jacketing layer 14 for bonding the insulation layer 12 to the jacketing layer 14. Accordingly, the insulation layer 12 may be made from materials such as polyethylene, polypropylene, ethylene propylene co-polymer, ethylene vinyl acetate and methylpentene co-polymer, and fills the area between the conductors 11 and the jacketing layer 14. The tie layer 16 generally includes a modified ethylene propylene co-polymer material grafted with an unsaturated anhydride, an acrylic acid, a carboxyl acid, or a silane and is used to bond the insulation layer 12 to the jacketing layer 14. The tie layer 16 is needed because many of the common insulation materials, such as polyolefin and fluoropolymers are not readily bonded, and when they are, they are often brittle and not capable of withstanding temperature and pressure requirements found in seismic, oceanographic and wireline cables.

FIG. 2 is an illustration of an electrical cable 110, in accordance with the prior art. The electrical cable 110 includes individually-insulated conductors 111 and has an insulation layer 112 and a jacketing layer 114 directly abutting the insulation layer 112. One of the insulation layer 112 or the jacketing layer 114 may include an integral tie layer material as a mixture. For example, one of the insulation layer 112 and the jacketing layer 114 may include ethylene propylene co-polymer and the other include a mixture of nylon and an ethylene propylene co-polymer grafted with an unsaturated anhydride. Further, the insulation layer 112 or the jacketing layer 114 may comprise a polymer grafted with an unsaturated anhydride within a range of about 20 weight percent of the layer to about 80 weight percent of the layer containing the mixture.

Cables with filler layers present complications when terminating the cable. Terminating the cable may be needed when a cable is shortened or connected with a connector to another cable. The cable portions may be connected with welded connectors, or another type of connector used in the industry. The complications with terminating are due to the fact that the filler layer or filler material must be removed from the cable prior to terminating it. Commonly, the removal of the filler material may require thermal or mechanical processes, which can be expensive, time consuming and may lead to additional complications with the cable. Furthermore, if the filler layer is not entirely removed, the cable may have weld defects with welding a jacketing material on the cable.

Another type of cable is a foamed polymer cable. The axial center of the foamed polymer cable includes a conductor, such as a seven strand, eighteen gauge, copper conductor. Enveloping the conductor is a fluoropolymer extrusion, such as TEFZEL®, sold by DUPONT FILMS®. Beyond the fluoropolymer extrusion is a polymer layer. A pneumatic void surrounds the polymer layer in the foamable polymer cable. Defining an outer limit of the pneumatic void is an armor shell. The pneumatic void is a temporary feature of the foamable polymer cable. However, the foamable polymer cable is flawed because the cross-sectional pneumatic void is so large that foaming the foamable polymer cable regularly yields an exocentric cable. Furthermore, the foamable polymer cable is not conducive to removing the filler layer during termination because of the chemical bonding.

Thus, a heretofore unaddressed need exists in the industry to address the aforementioned deficiencies and inadequacies.

### SUMMARY OF THE DISCLOSURE

Embodiments of the present disclosure provide a system and method for a down-hole cable having a liquid bonding system. Briefly described, in architecture, one embodiment of the system, among others, can be implemented as follows. The system contains at least one insulated conductor fully insulated by an insulation coating. An armor shell is positioned exterior to the insulating coating and fully surrounds the insulated conductor. A liquid bonding material is applied between at least a portion of an exterior surface of the insulation coating and at least a portion of an interior surface of the armor shell, wherein the liquid bonding material creates a bond between the insulation coating and the armor shell.

The present disclosure can also be viewed as providing methods for making a down-hole cable having a liquid bonding system. In this regard, one embodiment of such a method, among others, can be broadly summarized by the following steps: providing at least one insulated conductor fully insulated by an insulation coating; positioning an armor shell exterior to the insulation coating, wherein the armor shell fully surrounds the insulated conductor; and applying a liquid bonding material between at least a portion of an exterior surface of the insulation coating and at least a portion of an interior surface of the armor shell, wherein the liquid bonding material creates a bond between the insulation coating and the armor shell.

The present disclosure can also be viewed as a down-hole cable for use in a substantially vertical position. Briefly described, in architecture, one embodiment of the system, among others, can be implemented as follows. At least one insulated conductor is fully insulated by an insulation coating. An armor shell is positioned exterior to the insulating coating and fully surrounding the insulated conductor. An epoxy-based bonding material is positioned between an exterior surface of the insulation coating and an interior surface of the armor shell. The bonding material is non-compressively securing the insulated conductor to the interior surface of the armor shell with an adhesive bond, wherein the at least one insulated conductor is retained from movement respective to the armor shell by the adhesive bond when the down-hole cable is positioned substantially vertical.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a cross-sectional illustration of an electronic cable, in accordance with the prior art.

FIG. 2 is a cross-sectional illustration of an electronic cable, in accordance with the prior art.

FIG. 3 is a cross-sectional illustration of a down-hole cable, in accordance with a first exemplary embodiment of the present disclosure.

FIG. 4 is a cross-sectional illustration of a down-hole cable, in accordance with the first exemplary embodiment of the present disclosure.

FIG. 5 is a cross-sectional illustration of a cable in a vertical orientation, in accordance with the first exemplary embodiment of the present disclosure.

FIG. 6 is a cross-sectional illustration of a down-hole cable, in accordance with a second exemplary embodiment of the present disclosure.

FIG. 7 is a cross-sectional illustration of a down-hole cable, in accordance with the second exemplary embodiment of the present disclosure.

FIG. 8 is a flowchart illustrating a method of making a down-hole cable, in accordance with the first exemplary embodiment of the present disclosure.

### DETAILED DESCRIPTION

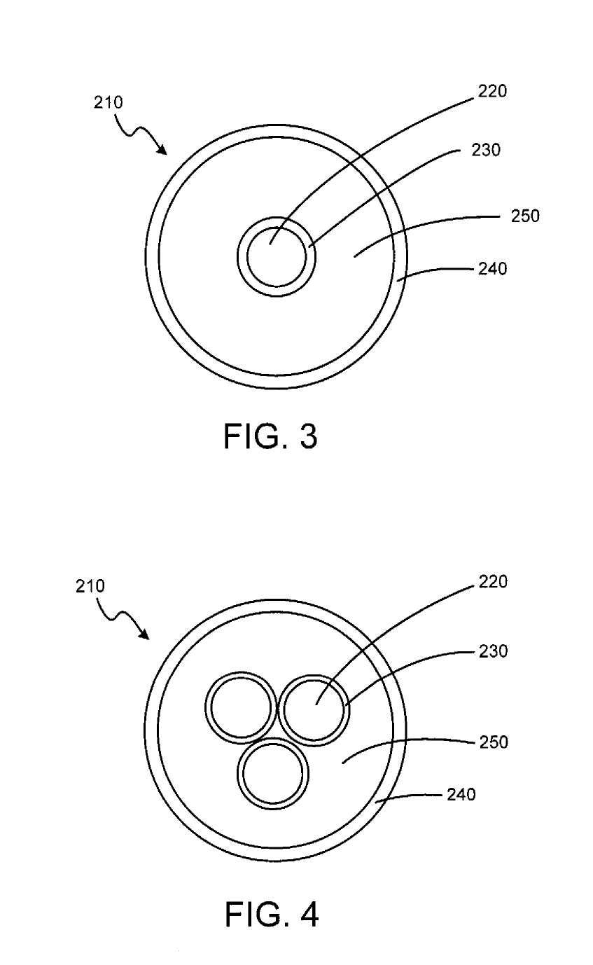

FIG. 3 is a cross-sectional illustration of a down-hole cable 210, in accordance with a first exemplary embodiment of the present disclosure. FIG. 4 is a cross-sectional illustration of a down-hole cable 210, in accordance with the first exemplary embodiment. The down-hole cable 210 may also be referred to as a tube-encapsulated conductor, a permanent down-hole cable, or simply as a cable. The cable 210 includes at least one insulated conductor 220 fully insulated by an insulation coating 230. An armor shell 240 is positioned exterior to the insulating coating 230 and fully surrounding the insulated conductor 220. A liquid bonding material 250 is applied between at least a portion of the exterior surface of the insulation coating 230 and at least a portion of the interior surface of the armor shell 240. The liquid bonding material 250 creates a bond between the insulation coating 230 and the armor shell 240. The cable 210 may be any wire, transmission line or similar structure that may be used in deep drilling operations, such as with onshore or offshore oil drilling. The insulated conductor 220 may include any material, which is capable of facilitating movement of electric charges, light or any other communication medium, which may be used in any industry. The insulated conductor 220 may include any conductor materials such as copper, aluminum, alloys, fiber electric hybrid materials, fiber optical materials, stranded or woven conductors or any other material known within the industry. The insulated conductor 220 may be capable of facilitating movement of energy capable of powering a device or facilitating a communication or control signal between devices. The insulated conductor 220 may include any number of insulated conductors 220, such as one insulated conductor 220 shown in FIG. 3 or more than one insulated conductor 220, as shown in FIG. 4.

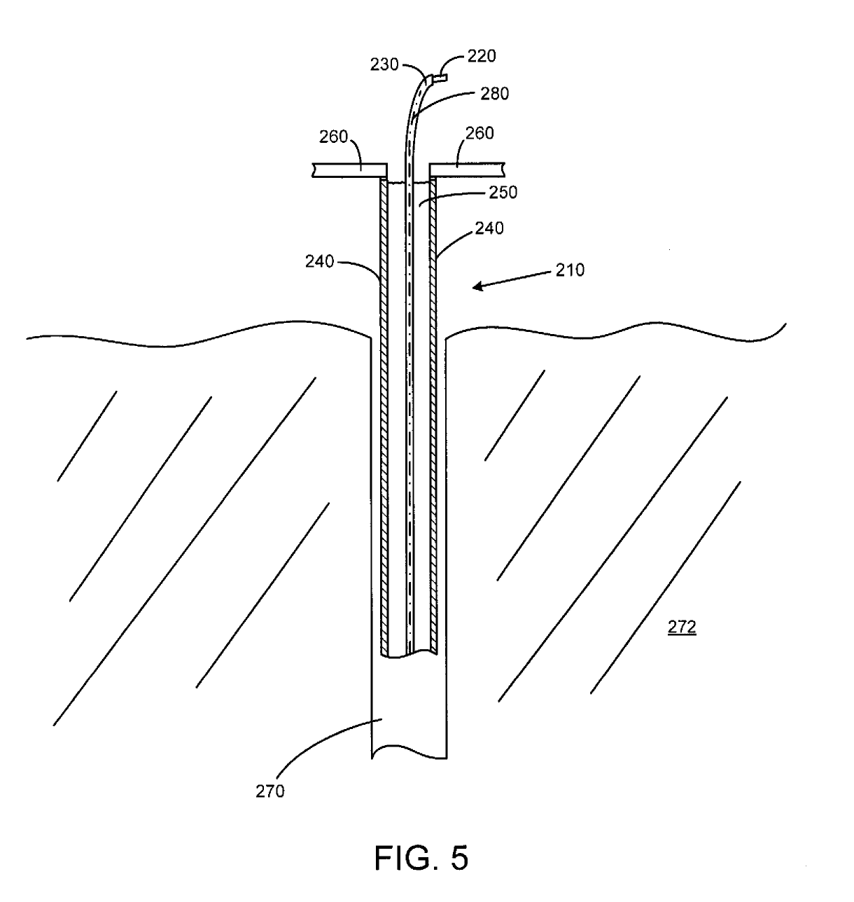

The insulation coating 230 surrounding the insulated conductor 220 may include any type of insulating material. This may include a thermoset or thermoplastic insulation coating material, such as an acrylic, epoxy or plastic. Preferably, each insulated conductor 220 is individually insulated with an insulation coating 230, whereby any communication or signal within one insulated conductor 220 is separated from a communication or signal within another insulated conductor 220. However, more than one insulated conductor 220 may be encapsulated by one insulation coating 230. For example, if different types of insulated conductors 220 are used within one cable 210, each type of insulated conductor 220 may require an individual insulation coating 230, whereas insulated conductors 220 of a common type may be insulated by a single insulated conductor 230. When more than one insulated conductor 220 is used, the insulation coatings 230 are preferably distinct from one another, wherein each insulated conductor 220 is individually identifiable. The insulated conductor 220 may be identifiable with an identification marking 280, as is shown in FIG. 5 and discussed further with respect thereto.

The armor shell 240 is a sheath or exterior coating or layer that is positioned exterior to the insulated coating 230 and fully surrounds the insulated conductor 220. This configuration allows the armor shell 240 to protect the inner components of the cable 210, including the insulated conductors 220 and the insulation coating 230 attached thereto. Any material, substance or layer located on the exterior of the cable 210 and capable of protecting the cable 210 may be considered an armor shell 240. The armor shell 240 may be constructed from a strong material, such as a stainless steel, a nickel-based alloy, or a corrosion resistant alloy, which protects the cable 210 from foreign objects penetrating the cable 210, such as debris from a drilling process. The armor shell 240 may also include any woven, solid, particulate-based and layered protecting materials.

The armor shell 240 may be substantially concentric to the insulated conductor portion 220, or it may be off-centered from an imaginary axis of the cable 210. For example, in some uses, it may be desirable to have the insulated conductor 220 be positioned at the center of the armor shell 240, whereas other uses may requires the insulated conductor 220 to be positioned directly abutting an interior surface of the armor shell 240. A cable 210 may also include variations in where the insulated conductor 220 is positioned. For example, the armor shell 240 may be positioned substantially concentric to the insulated conductor 220 at one place along the length of the cable 210, and in an off-centered position at another place on the cable 210. The positioning of the insulated conductor 220 may be dependent on the type or quantity of liquid bonding material 250 used.

The liquid bonding material 250 may include any type or types of materials that are capable of creating a bond between two materials. Preferably, this will include an epoxy adhesive with an epoxide resin and a polyamine hardener, but any other type of adhesive or bonding material is considered within the scope of the present disclosure, including an acrylic, thermorset or thermopolymer material. The liquid bonding material 250 is applied between at least a portion of an exterior surface of the insulation coating 230 and at least a portion of an interior surface of the armor shell 240. This may include placing the liquid bonding material 250 about the entire exterior surface of the insulation coating 230, whereby any portion of the insulation coating 230 will bond to the armor shell 240. Likewise, the liquid bonding material 250 may be placed along the entire interior surface of the armor shell 240, whereby the insulation coating 230 will bond to any portion of the interior surface of the armor shell 240. This may also include using enough liquid bonding material 250 to fully engulf the interior portion of the cable, i.e., the portion between the exterior surface of the insulation coating 230 and the interior surface of the armor shell 240.

In accordance with this disclosure, the liquid bonding material 250 may include materials that are initially liquid, or substantially liquid, but that are transformed into a substantially non-liquid material. For example, the liquid bonding material 250 may be applied to the cable 210 in a substantially liquid state, but may then be hardened into a non-liquid material. Accordingly, the liquid bonding material 250 may require a catalyst or some procedure to create a substantial bond between the exterior surface of the insulation coating 230 and at least a portion of an interior surface of the armor shell 240. Catalysts may include heat, an elapsed period of time, a chemical interaction, ultraviolet curing, moisture curing, or the like.

As discussed within the background, conventional cables include filler layers around the conductor materials to reduce the movement of the conductor materials within the cable. The cable 210 of the first exemplary embodiment does not require a filler layer within the cable 210, nor is it advantageous for a filler layer to be included with the cable 210. For example, the cable 210 may be limited to only an insulated conductor 220, an insulation coating 230, the liquid bonding material 250 and the armor shell 240, whereby no filler materials are used. When no filler materials are used, termination of the cable may be completed without the complications of removing a filler layer, which may reduce expenses and the time needed to terminate a cable, among other benefits.

The use of the liquid bonding material 250 creates a cable 210 with a high structural integrity, whereby the interior components of the cable 210, including the insulated conductors 220, may be retained within the armor shell 240, especially when the cable 210 is positioned in a substantially vertical orientation. The liquid bonding material 250 may non-compressively secure the insulated conductor 220 to the armor shell 240 with the liquid bonding material 250. Accordingly, the compressive force created by the filler layer of conventional cables is not present in the cable 210. Rather, the liquid bonding material 250 may use only adhesive forces from an adhesive bond to retain the insulated conductor 220 in a stationary position with respect to the armor shell 240. This prevents movement of the components of the cable 210 within the armor shell 240, thereby allowing it to be used in high-stress conditions, such as those experiences in down-hole drilling operations. This construction allows for a cable that can be used for both horizontal and vertical purposes without compromising the integrity or utility of the cable 210 and without the need for a compressive force on the insulated conductors 220. This construction also allows the cable 210 to be used in a variety of temperatures, including all temperatures, such as temperatures up to 250° C., 500° C., or a temperature higher than 500° C.

FIG. 5 is a cross-sectional illustration of a cable 210 in a vertical orientation, in accordance with the first exemplary embodiment of the present disclosure. As is illustrated, the cable 210 is positioned substantially vertical within a hole 270 that is present within the ground 272. This orientation of the cable 210 may be needed in operations where the cable 210 is at least partially placed within a drilled or bored hole within the Earth or a body of water, such as an ocean. As can be seen, the armor shell 240 of the cable 210 may be positioned proximate to the ground 272, which may include materials such as rock, dirt, soil, water, or a combination thereof. The armor shell 240 may prevent articles within the ground 272 from penetrating the cable 210 and causing damage to a component within the cable 210. For example, the armor shell 240 may prevent rocks or other objects from damaging the cable 210 while it is placed within the hole 270.

Additionally, the armor shell 240 may be used to secure the cable 210 in a specific position via an attachment to one or more anchoring structures 260. In FIG. 5, the anchoring structures 260 are illustrated at an upper end of the cable 210, although they may be placed along any part of the cable 210, including the bottom or a mid-section. Furthermore, the armor shell 240 may also support the cable 210 between two anchoring structures 260, or in any position within a hole 270. This arrangement enables tensile or compressive forces, many of which may be generated from the weight of the cable 210 to be transferred to the armor shell 240 instead of the insulated conductor 220. As is illustrated in FIG. 5, an identification marking 280 may be included on the insulation coating 230 attached to the insulated conductor 220. The identification marking 280 may include any type of marking commonly used on cables, including specific line configurations, colors, written text or textural elements.

In operation, the cable 210 may be placed with one end of the cable 210 in a position that is substantially above the other end of the cable 210. In addition to a vertical positioning, the cable 210 may also be positioned to run any horizontal length, alone or in combination with a vertical length. This cable 210 may be any length, such as 100 feet, 300 feet, 500 feet or greater, or any other length. For example, the cable 210 may be suspended within a hole drilled within the Earth's crust, wherein one end of the cable 210 is located above the Earth's crust and the other end is located 500 feet or more below the Earth's crust. The cable 210 may be held in this position for any period of time, and thus, the cable 210 must be resistant to the pullout force created by gravity acting on the insulated conductor(s) 220. In other words, the liquid bonding material 250 bonding the insulation coating 230 to the armor shell 240 may offset any pullout force created by gravity. The cable 210 may be suitable for any vertical use, and may be especially preferable for vertical use spanning a distance of 500 feet or more. As one having ordinary skill in the art would recognize, many variations, configurations and designs may be included with the cable 210, or any component thereof, all of which are considered within the scope of the disclosure.

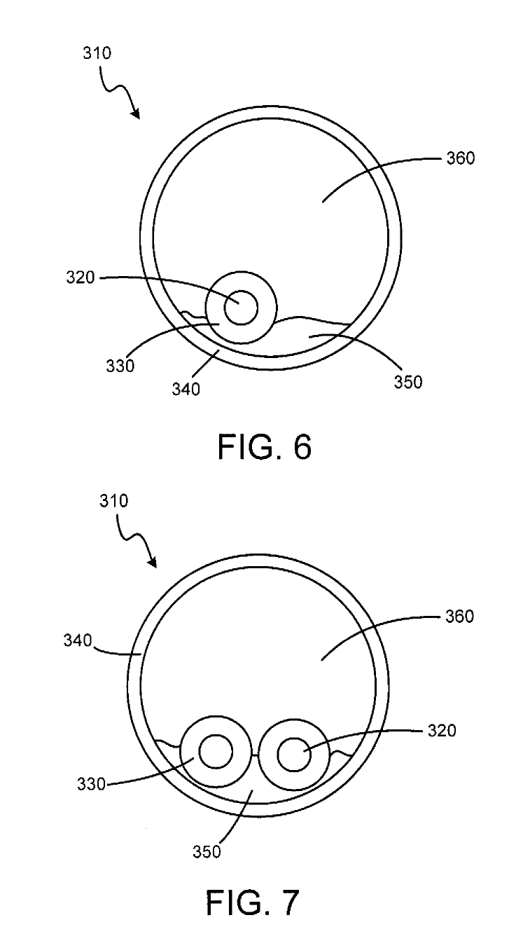

FIGS. 6 and 7 are cross-sectional illustrations of a cable 310, in accordance with a second exemplary embodiment of the present disclosure. The cable 310 is similar to that of the cable 210 of the first exemplary embodiment, the disclosure of which including any components, configurations or characteristics discussed therein, is considered within the scope of the second exemplary embodiment. As shown, the cable 310 includes at least one insulated conductor 320 fully insulated by an insulation coating 330. Specifically, FIG. 6 illustrates only one insulated conductor 320, whereas FIG. 6 illustrates more than one insulated conductor 320. An armor shell 340 is positioned exterior to the insulating coating 330 and fully surrounds the insulated conductor 320. A liquid bonding material 350 is applied between at least a portion of the exterior surface of the insulation coating 330 and at least a portion of an interior surface of the armor shell 340. The liquid bonding material 350 creates a bond between the insulation coating 330 and the armor shell 340.

In addition to the liquid bonding material 350, the cable 310 includes a gas pocket 360 proximate to at least one of the insulated conductor 320 and the liquid bonding material 350. The gas pocket 360 may further include any number of gas pockets 360 that are filled with any type of gas. For example, the gas pocket 360 may be created during construction of the cable 310, wherein oxygen, nitrogen or another gas, or a combination of two or more gasses are trapped within the cable 310. This may include a continuous or non-continuous gas pocket 360 created because the liquid bonding material 350 does not fill the interior portion of the armor shell 340, or only partially fills the inner portion of the armor shell 340. Alternatively, the gas pocket 360 may be created by purposefully placing gas within the cable 310, such as to cure the liquid bonding material 350. Any design, configuration or arrangement of the cable 310 with a gas pocket 360 is considered within the scope of the present disclosure. The gas pocket 360 may include a pneumatic cavity extending the length of the cable 310.

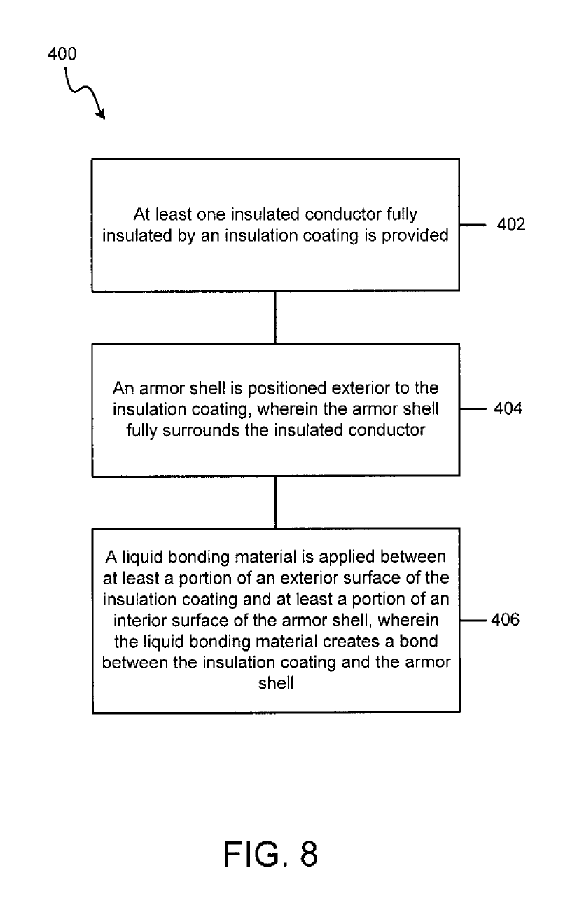

FIG. 8 is a flowchart 400 illustrating a method of making the abovementioned down-hole cable 310 in accordance with the second exemplary embodiment of the disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 402, at least one insulated conductor 320 fully insulated by an insulation coating 330 is provided. An armor shell 340 is positioned exterior to the insulation coating 330, wherein the armor shell 340 fully surrounds the insulated conductor 320 (block 404). A liquid bonding material 350 is applied between at least a portion of an exterior surface of the insulation coating 330 and at least a portion of an interior surface of the armor shell 340, wherein the liquid bonding material creates a bond between the insulation coating 330 and the armor shell 340 (block 406).

The method may further include additional steps, such as the step of enclosing a gas pocket interior to the armor sheath and proximate to at least one of the insulated conductor and the liquid bonding material. Furthermore, the method of making the down-hole cable 310 may include the step of applying the liquid bonding material before, during or after a process of applying, constructing or welding the armor shell. For example, the application of an epoxy as the liquid bonding material may be inline during a welding operation with a metallic armor shell, and applied before or after the weld point of the armor shell.

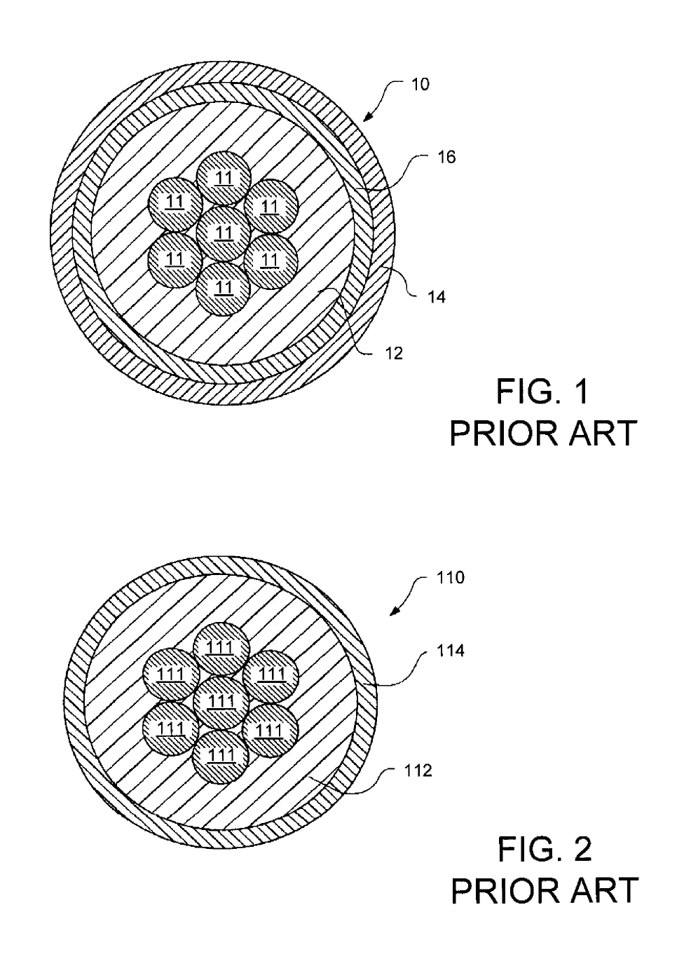

Any of the steps or processes discussed with respect to FIGS. 1-7 may also be included in the method. For example, the at least one insulated conductor may be retained in a substantially stationary position with respect to the armor shell using the liquid bonding material. The liquid bonding material may also apply a non-compressive force on the insulated conductor by the liquid bonding material. Additionally, a liquid bonding material may be applied between at least a portion of the exterior surface of the insulation coating and at least a portion of an interior surface of the armor shell to fully engulf an interior portion of the cable positioned between the exterior surface of the insulation coating and the interior surface of the armor shell. Any liquid bonding material may be cured with at least one catalyst, which may include a heated application, an elapsed period of time, a chemical reaction, an ultraviolet light application and/or a moisture curing application. Additionally, the armor shell may be connected to at least one anchoring structure, which may be used to secure the cable in a substantially vertical position. Other variations, steps and procedures may also be included with applying the liquid bonding material, all of which are considered within the scope of the present disclosure.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment of the disclosure without departing substantially from the spirit and principles of the disclosure. All such modifications and variations are intended to be included herein within the scope of this disclosure and the present disclosure and protected by the following claims.

What is claimed is:

1. A down-hole cable comprising:
at least one insulated conductor fully insulated by an insulation coating;
an armor shell positioned exterior to the insulating coating and fully surrounding the insulated conductor; and
a liquid bonding material applied between at least a portion of an exterior surface of the insulation coating and at least a portion of an interior surface of the armor shell, wherein the liquid bonding material creates a bond between the insulation coating and the armor shell.

2. The down-hole cable of claim 1, further comprising a gas pocket located proximate to at least one of the insulated conductor and the liquid bonding material.

3. The down-hole cable of claim 1, wherein the armor shell is positioned substantially concentric to the at least one insulated conductor.

4. The down-hole cable of claim 1, wherein the armor shell is positioned off-centered from to the at least one insulated conductor.

5. The down-hole cable of claim 1, wherein the liquid bonding material fully engulfs an interior portion between the exterior surface of the insulation coating and the interior surface of the armor shell.

6. The down-hole cable of claim 1, wherein the bond between the insulation coating and the armor shell further comprises an adhesive bond.

7. The down-hole cable of claim 1, wherein the at least one insulated conductor further comprises a plurality of insulated conductors, wherein each of the plurality of insulated conductors is individually and fully insulated by the insulation coating.

8. The down-hole cable of claim 7, wherein each of the plurality of insulated conductors includes at least one identification marking.

9. The down-hole cable of claim 1, wherein the armor shell is connected to at least one anchoring structure.

10. The down-hole cable of claim 1, wherein the liquid bonding material further comprises an epoxy adhesive having an epoxide resin and a polyamine hardener.

11. The down-hole cable of claim 1, wherein the liquid bonding material retains the at least one insulated conductor in a substantially stationary position with respect to the armor shell.

12. The down-hole cable of claim 1, wherein the liquid bonding material applies a non-compressive force on the insulated conductor.

13. A method of making a down-hole cable, the method comprising the steps of:
providing at least one insulated conductor fully insulated by an insulation coating;
positioning an armor shell exterior to the insulation coating, wherein the minor shell fully surrounds the insulated conductor; and
applying a liquid bonding material between at least a portion of an exterior surface of the insulation coating and at least a portion of an interior surface of the armor shell, wherein the liquid bonding material creates a bond between the insulation coating and the armor shell.

14. The method of making a down-hole cable of claim 13, further comprising the step of enclosing a gas pocket interior to the armor sheath and proximate to at least one of the insulated conductor and the liquid bonding material.

15. The method of making a down-hole cable of claim 13, wherein the step of applying a liquid bonding material between at least a portion of the exterior surface of the insulation coating and at least a portion of an interior surface of the armor shell further comprises fully engulfing an interior portion of the cable positioned between the exterior surface of the insulation coating and the interior surface of the armor shell.

16. The method of making a down-hole cable of claim 13, further comprising the step of connecting the armor shell to at least one anchoring structure.

17. The method of making a down-hole cable of claim 13, further comprising the step of applying a non-compressive force on the insulated conductor by the liquid bonding material.

18. The method of making a down-hole cable of claim 13, further comprising the step of curing the liquid bonding material with at least one of a heated application, an elapsed period of time, a chemical reaction, an ultraviolet light application and a moisture curing application.

19. The method of making a down-hole cable of claim 13, further comprising the step of retaining the at least one insulated conductor in a substantially stationary position with respect to the armor shell using the liquid bonding material.

20. A down-hole cable for use in a substantially vertical position, the down-hole cable comprising:
at least one insulated conductor fully insulated by an insulation coating;
an armor shell positioned exterior to the insulating coating and fully surrounding the insulated conductor; and
an epoxy-based bonding material positioned between an exterior surface of the insulation coating and an interior surface of the armor shell, the bonding material non-compressively securing the insulated conductor to the interior surface of the armor shell with an adhesive bond, wherein the at least one insulated conductor is retained from movement respective to the armor shell by the adhesive bond when the down-hole cable is positioned substantially vertical.
